(19) United States
(12) Patent Application Publication
(10) Pub. No.: US 2001/0035399 A1
(43) Pub. Date: Nov. 1, 2001

(54) Method and apparatus for improved arc initiation

(76) Inventors: Zheng Geng, Toronto (CA); Hongzhi Xin, Toronto (CA); Thomas North, Burlington (CA)

Correspondence Address: DOWELL & DOWELL PC, SUITE 309, 1215 JEFFERSON DAVIS HIGHWAY, ARLINGTON, VA, 22202

(21) Appl. No.: 09/785,551

(22) Filed: Feb. 20, 2001

Related U.S. Application Data
(60) Provisional application No. 60/206,265, filed on May 23, 2000.

(51) Int. Cl. B23K 10/00

(52) U.S. Cl. 219/121.46; 219/121.45; 219/121.57; 219/76.16

(57) ABSTRACT

This invention provides a method and apparatus for improved arc initiation during Gas-Metal Arc welding. The unstable period at the arc start is a period when increased spatter is produced and increased fume is generated and defects such as unacceptable weld bead profiles, porosity and inadequate penetration occur. It has been observed that initiating the arc using a substantially higher average arc current and thereafter switching the power supply to a CV mode for the remainder of the Gas-Metal Arc welding operation decreases the arc initiation period and the instability produced during this arc start period. Initiating the arc using a CC supply and then dynamically switching on-line the power supply to CV operation provides a means of decreasing the arc initiation period and the amount of instability produced during the arc initiation period. Power supplies for Gas-Metal Arc welding and other applications requiring on-line switching between CC and CV are disclosed.

### CROSS REFERENCE TO RELATED U.S. PATENT APPLICATION

This patent application relates to U.S. Provisional Patent Application Serial No. 60/206,265 filed on May 23, 2000, entitled IMPROVED ARC INITIATION.

### FIELD OF THE INVENTION

The present invention relates to a method and apparatus for arc welding, and more particularly the invention relates to a method and apparatus for improving arc initiation during Gas-Metal Arc welding.

### BACKGROUND OF THE INVENTION

In the majority of industrial applications of Gas-Metal Arc welding (GMA) the welding parameters are selected so that the spray transfer mode of droplet transfer occurs during the welding operation. Spray transfer occurs when a stream of metal droplets having diameters less than the electrode diameter are produced during the arc welding operation. When the spray transfer mode of droplet transfer is employed this produces the highest weld quality, operability and optimum profiles during welding. However, when the arc welding operation initiates it takes a certain amount of time before the spray transfer mode of metal transfer can be established, see FIG. 1. This initiation time, also referred to as the arc start time, is a period during which the arc behaves in an unstable manner and mixed-metal transfer occurs comprising a combination of short-circuit, globular and spray transfer modes. FIG. 2 shows typical arc current and voltage traces and high-speed CCD images of metal transfer during the period following an arc start. When the arc initiates the electrode shorts with the workpiece surface and the arc current rises rapidly. A series of irregularly short circuits are produced, larger diameter droplets are formed on the electrode tip (see images #7, #8, #16 and #17 in FIG. 2), the wire is sheared and whole arc initiation process has to begin again (see images #4, #5 and #6 in FIG. 2).

Arc outages also occur during arc initiation, often accompanied by severing of the electrode wire in the region between the contact tip and the weld pool. Arc instability during arc starts increases the amount of spatter (the amount of molten metal ejected from the arc envelope) and the amount of fume (increased fume is the natural outcome of arc instability). Moreover, many types of welding defects can be produced during arc initiation as a result of the unstable arcing behavior, e.g., porosity, poor weld deposit profile and decreased penetration of the components being fabricated. With this in mind, it is a critical aim that welding fabricators should decrease the arc initiation (arc start) period. Although the problems caused by poor arc initiation are associated with manual and mechanized welding operations (where the welding head or workpiece are machine-driven) robotic welding applications are a critical area (since defect formation and poor weld profiles may require manual intervention). This is particularly the case when the total welding time is small.

It would be very advantageous therefore to provide a method and apparatus for improving arc initiation during gas metal arc welding.

### SUMMARY OF THE INVENTION

The present invention provides a method of Gas-Metal Arc welding, comprising:

initiating a plasma arc between an electrode wire and a metallic workpiece to be welded using a power supply having a preselected substantially constant current output during an arc initiation period of time and thereafter the power supply being dynamically switched on-line to provide a preselected substantially constant voltage output giving a stable arcing period during Gas-Metal Arc welding.

The present invention also provides a power supply controller for retrofitting to a power supply for on-line dynamic switching of the power supply between a constant current mode and a constant voltage mode, comprising:

a current selection means connected to said power supply for selecting a value of the current at an output of said power supply in the constant current mode, switch means connected to said power supply for switching said power supply between said constant current mode and said constant voltage mode on-line, voltage selection means connected to said switch means for selecting a value of the voltage at said output in the constant voltage mode, time selection means connected to said switch means for selecting an amount of time a constant current or constant voltage is applied to said output.

The present invention provides a power supply system that can be dynamically switched on-line between a constant current mode and a constant voltage mode, comprising:

a power supply having an output for delivering a current or voltage signal;

a power supply controller connected to said power supply for controlling constant current mode and constant voltage mode characteristics of said power supply, said controller including current selection means connected to said power supply for selecting a value of the constant current at said output, switch means connected to said power supply for switching said power supply on-line between said constant current mode and said constant voltage mode, voltage selection means connected to said switch means for selecting a value of the constant voltage at said output, time selection means connected to said switch means for selecting an amount of time a constant current or constant voltage is applied to said output.

The present invention also provides a welding system for Gas-Metal Arc welding, comprising:

a power supply having a first output connected to an electrode wire and a second output connected to a workpiece to be welded, said power supply being adapted to operate in a constant current mode during an arc initiation period and thereafter in a constant voltage mode;

a power supply controller connected to said power supply for controlling constant current mode and constant voltage mode characteristics of said power supply and on-line dynamically switching said power supply between said constant current mode and said constant voltage mode;

a wire feeder for feeding electrode wire to a workpiece at which welding is to occur; and

a gas supply for providing a shielding gas to a welding site at said workpiece.

### BRIEF DESCRIPTION OF THE DRAWINGS

The following is a description, by way of example only, of a method and apparatus for rapidly increasing the arc current up to a level that permits spray metal transfer and maintains this arc current level during arc initiation, reference being had to the accompanying drawings, in which:

FIG. 1 shows typical current and voltage versus time plots for arc welding initiation using a prior art method showing that it takes a certain amount of time before the spray transfer mode of metal transfer can be established;

FIG. 2 shows typical arc current and voltage traces and associated high-speed charge-coupled device (CCD) images of metal transfer during the period following an arc start in the prior art method;

FIG. 3 shows the arc initiation period during arc welding using a wire feed speed of 500 IPM and an arc voltage of 31 volts using a prior art power supply;

FIG. 4 shows that the use of a CC power source allows the welding system to produce the higher and stable arc current value needed for stable arc operation;

FIG. 5 is a block circuit diagram of a power supply constructed in accordance with the present invention that provides a higher and stable arc current during arc initiation period and constant voltage (CV) operation of the gas metal arc process after a stable arc has been obtained;

FIG. 6 is a schematic diagram showing an online CC-CV switch system providing improved arc initiation when used with the power supply shown in FIG. 5;

FIG. 7 shows the waveforms produced by the different components shown in the FIG. 6;

FIG. 8 shows the current variations when power source conditioning is applied (this shows the current variations during the arc starting period and during the stable arcing period that follows arc initiation);

FIG. 9 shows a schematic diagram of a commercial inverter CC power supply controlled using a power source controller constructed in accordance with the present invention; and

FIG. 10 shows a schematic diagram of a commercial chopper-based CC power supply controlled by using a power source controller constructed in accordance with the present invention.

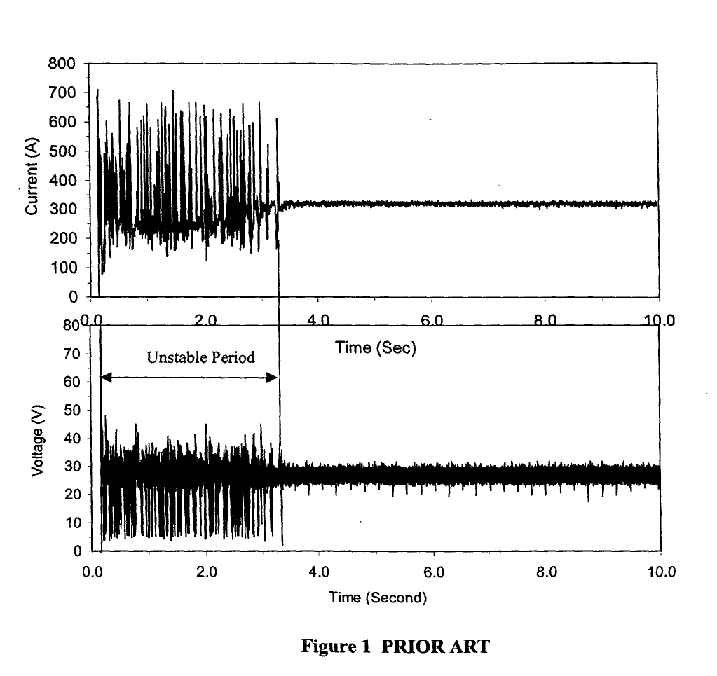

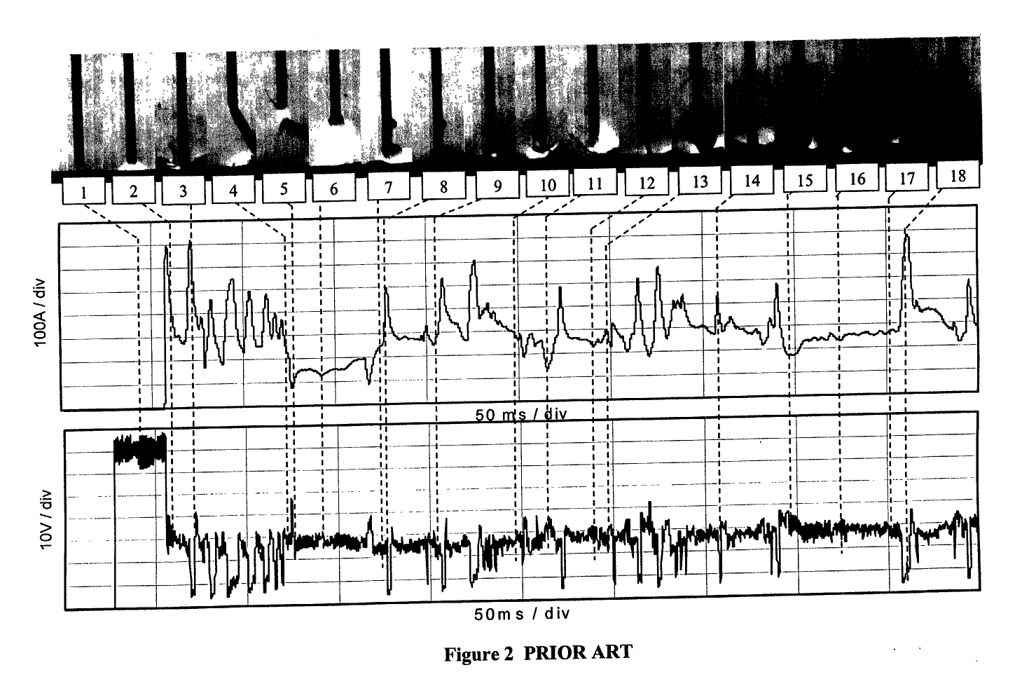

### DETAILED DESCRIPTION OF THE INVENTION

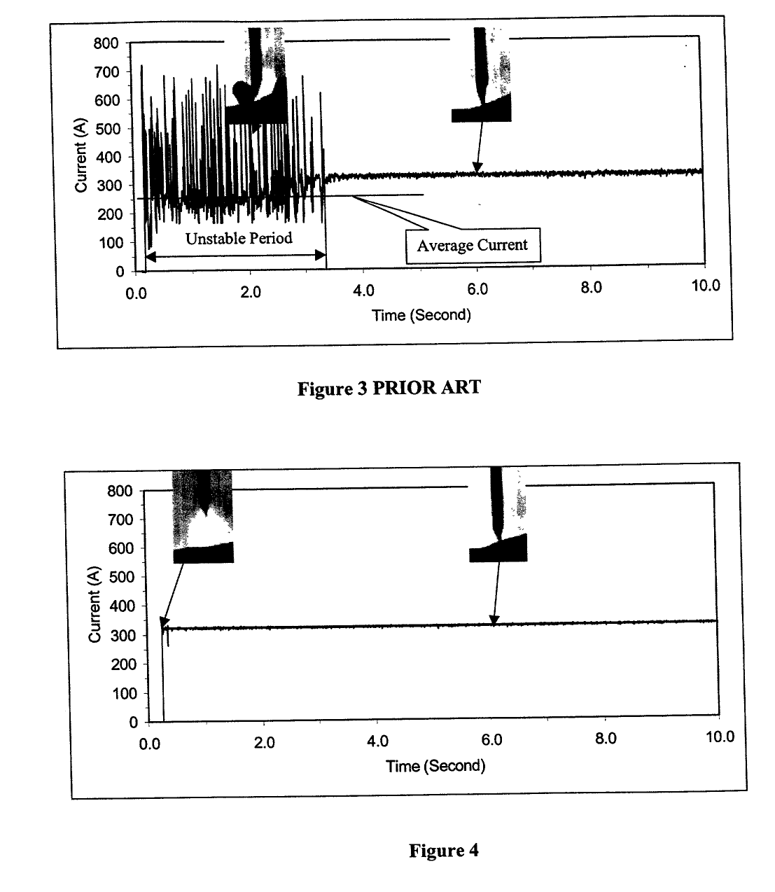

In tests examining arc current and arc voltage variations during arc initiation the inventors have observed that the arc current during the unstable period is very unstable and its average level is also much less than the average current needed during the stable period when spray metal transfer mode has been established and the arc welding process is operating in a stable manner (see FIG. 3). Specifically, FIG. 3 shows the arc initiation period during arc welding using a wire feed speed of 500 IPM, a steel wire diameter of 1.2 mm and an arc voltage of 31 volts. The spray metal transfer mode occurs when the arc current is 325 amps. However, during the unstable period when the arc is initiated, the average current is around 250 amps, much less than that during the stable arcing period. In short, the average arc current during the unstable period is much lower than the average current during the stable arcing period.

The unstable period during arc initiation may be visualized as a period where the average arc current increases up to the current level required for stable operation. The present invention described hereinafter provides a way of rapidly increasing the arc current and maintaining it at a high and stable level during arc start-up in order to reduce the instability period that occurs during arc initiation.

The average arc current during the arc start is low because the arc comprises high temperature plasma where the current is carried by electrons and positively charged ions. During arc initiation, the arcing zone between the electrode wire and the workpiece is at a lower temperature, insufficient electrons and positive ions are produced and the conductivity of the arc is reduced. During Gas-Metal Arc welding, a CV (constant voltage) power source is used since this produces a self-adjusting arc melting system during the welding operation. However, during the arc starting period use of a CV power source necessarily produces a lower average current value because the arc has a poor conductivity. When the arcing time increases following arc initiation, the weld pool dimensions increase and increased contents of metal vapor are generated so that the conductivity of the arc increases. Increased arc conductivity will cause the arc average current to increase up to a level that allows establishment of a stable spray metal transfer mode. The time required for the arc conductivity to increase is the unstable period following an arc start.

Based on the foregoing discussion, it will be understood that the arc initiation period and the instability that is observed during this period can be reduced by employing some means of rapidly increasing the arc current and maintaining it stable during the arc initiation period. One way of achieving this involves the use of a constant current (CC) power source since this type of power source can maintain the arc current at the required high and stable value. FIG. 4 shows that the use of a CC power source allows the welding system to attain the average current value needed for stable arc operation (when spray metal transfer occurs). It is apparent from FIG. 4 that the use of a CC power source markedly reduces the arc start period and the arc instability that occurs during this period of time. However, when a CC power source is used it is difficult to keep the arc length constant during Gas-Metal Arc welding following the completion of the arc start and this is why a CV power source is generally applied throughout industry.

The present method of rapidly increasing the arc current and maintaining it substantially stable during the arc initiation period therefore uses an on-line, dynamically switched CC/CV power supply that initiates the arc with the power supply in the CC mode and then switches on-line to CV operation once the stable arcing period is attained. Whereas conventional CC/CV power supplies are switchable off-line, dynamic as used herein means switchable on-line during the arc initiation period to control and adjust the CC output according to the preset condition. Since arc starts and the unstable period that accompanies them depends on the electrode diameter and on the type of welding consumable employed during GMA welding (solid wire, metal cored wire, flux-cored wire and so on) a modified CC/CV power source would require special circuitry enabling handling of all type of electrode wire consumables and diameters when welding using a variety of wire feed speed settings and shielding gases.

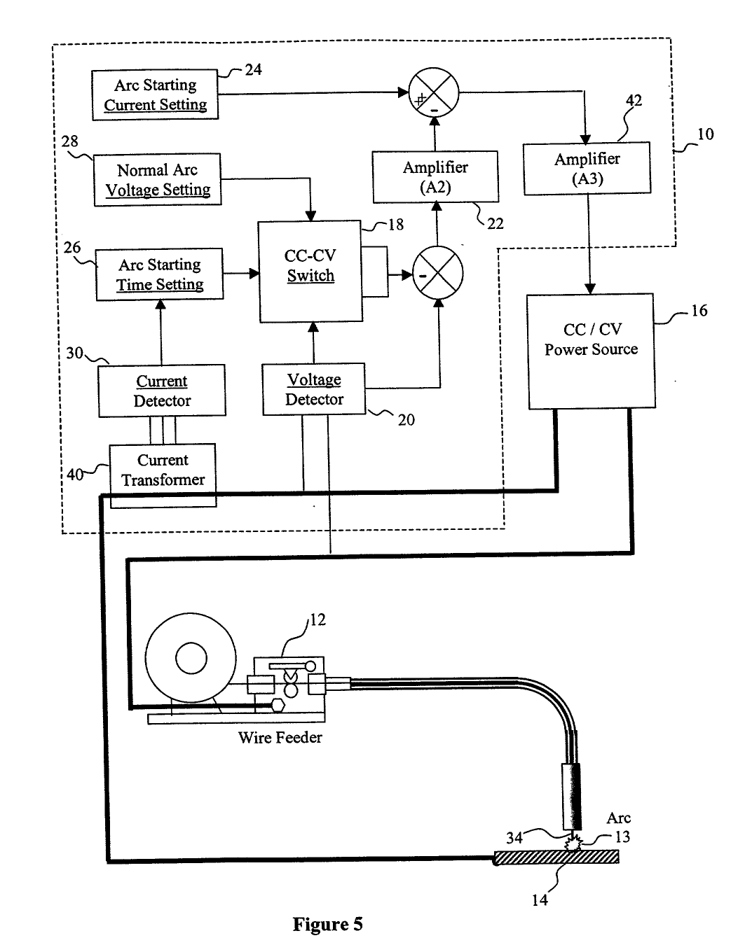

A block diagram of an exemplary, non-limiting example of a combined power source control unit 10 (also referred to as a power source conditioner (PSC)) and power supply 16 constructed in accordance with the present invention is shown in FIG. 5. During welding power supply 16 is connected to the metallic workpiece 14 that is being welded and to a wire feeder 12 that feeds electrode wire 36 to workpiece 14. Power supply 16 is a CC/CV power supply, which has its CC volt-amp characteristic dynamically switched on-line to a CV volt-amp characteristic due to the output of a switch 18 in the control unit 10 to be described hereinafter. As discussed above, those skilled in the art will understand that typical prior art CC/CV power supplies are designed to operate in either the CC mode or the CV mode and to switch between the two modes requires the operator to turn off the power supply and manually/mechanically switch it from one mode to the other after the power supply is turned on. Controller 10 being integrated with power supply 16 provides for the dynamic on-line switching from CC mode to CV mode which gives the very surprisingly stable arc initiation period and better quality welds.

More particularly, during the arc initiation period, the output of the CC-CV switch unit 18 is set equal to the output voltage feedback signal from the voltage detector unit 20. This makes the output of the amplifier A2 in unit 22 zero and therefore voltage feedback is prevented and the CC power source unit 16 produces a constant current characteristic, which has an output value determined by the arc-starting current setting unit 24. The arc-starting time setting unit 26 sets the time during which the power source 16 produces a constant current output characteristic.

At the end of the arc-initiation period the output of the CC-CV switch unit 18 is made equal to the normal arc voltage setting unit 28. The output of the amplifier A2 in unit 22 is proportional to the difference between the output of the normal arc-voltage setting unit 28 and the voltage detector 20. The resulting voltage feedback makes the CC power source 16 switch to a constant voltage (CV) characteristic mode of operation.

Three parameters can be selected during power source conditioning: the starting arc current as selected by arc starting current setting unit 24, the normal arc voltage as set by the normal arc voltage setting unit 28 and the arc starting time as selected by the arc starting time setting 26. The arc initiation current setting unit 24 controls the output current when the power source 16 is operating as a CC supply. The arc starting current setting will be determined by the wire-feed-speed, wire diameter and the type of shielding gas employed during Gas-Metal Arc welding. The normal arc voltage setting unit 28 is the signal source that sets the output voltage of the CC power supply 16 when it operates in the constant voltage mode. The output voltage setting is chosen so that stable spray metal transfer will occur when a given wire-feed-speed, wire diameter and shield gas composition are used during Gas-Metal Arc welding. The arc-starting time setting unit 26 is a timer that is triggered by the current detector 30. The arc-starting time setting will vary depending on the wire feed speed, wire diameter and type of shielding gas employed during the welding operation.

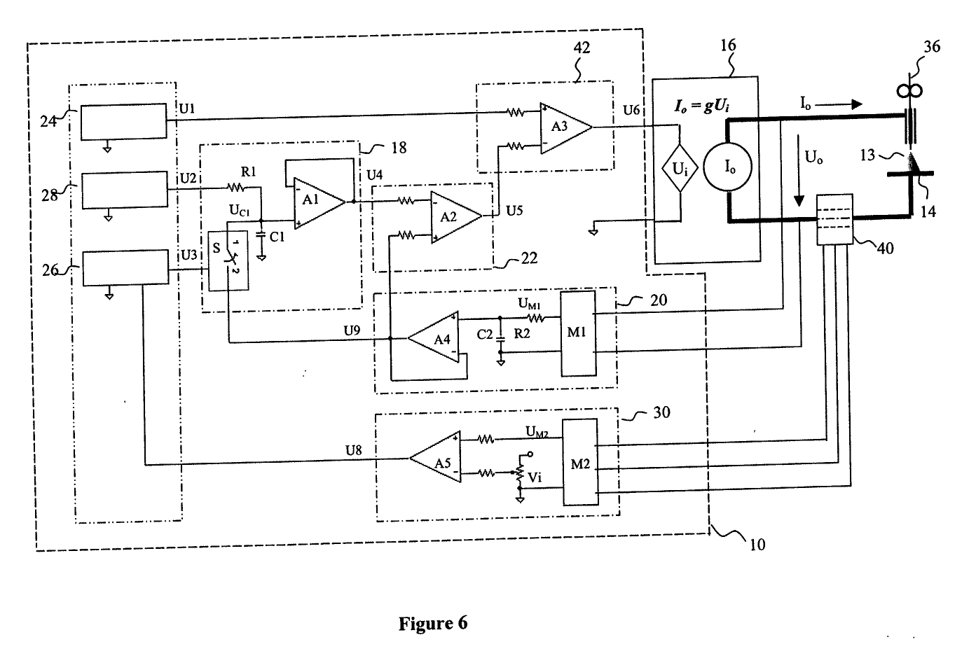

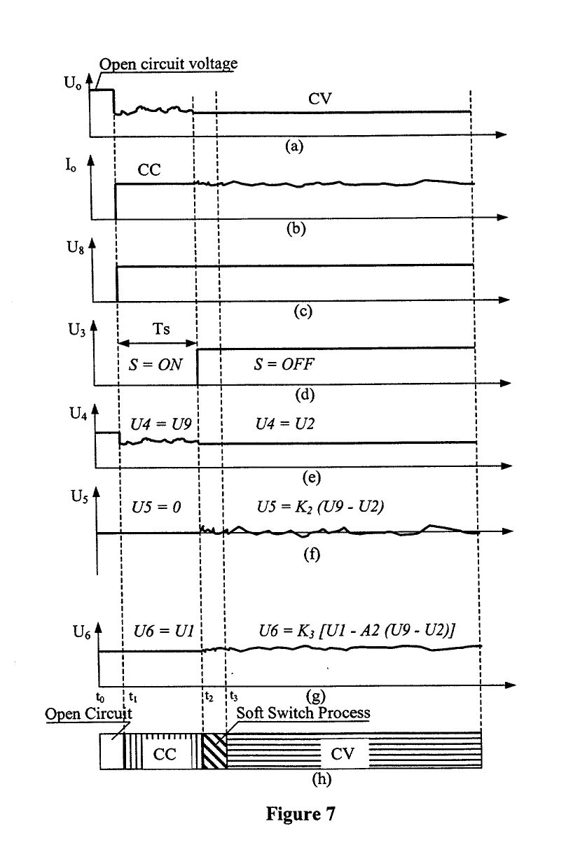

FIG. 6 is a schematic circuit diagram showing the key components in the power source controller unit 10 of FIG. 5. FIG. 7 shows the waveforms produced using the different components indicated in FIG. 6. These waveforms illustrate how the power source conditioning unit switches the power supply from a CC to a CV mode of operation during the period following an arc start. The CC power source 16 is triggered at time t₀, but an arc is not established between the tip of the electrode wire 36 and the workpiece 14 until the wire 36 being fed by the wire-feeding unit 12 makes contact with the workpiece 14. The arc current is zero during the period from t₀ until t₁ (see FIG. 7(b)) and the output of the CC power source 16 is consequently open circuit. The open circuit voltage Uₒ during the period from t₀ to t₁ is about 60 volts, see FIG. 7(a). The CC power source 16 can be considered as an ideal constant current source that is controlled by an input voltage signal, which has the form: I₀=gUᵢ, where, Iₒ is the output current, Uᵢ is the input voltage and g is the conversion rate (amps per volt).

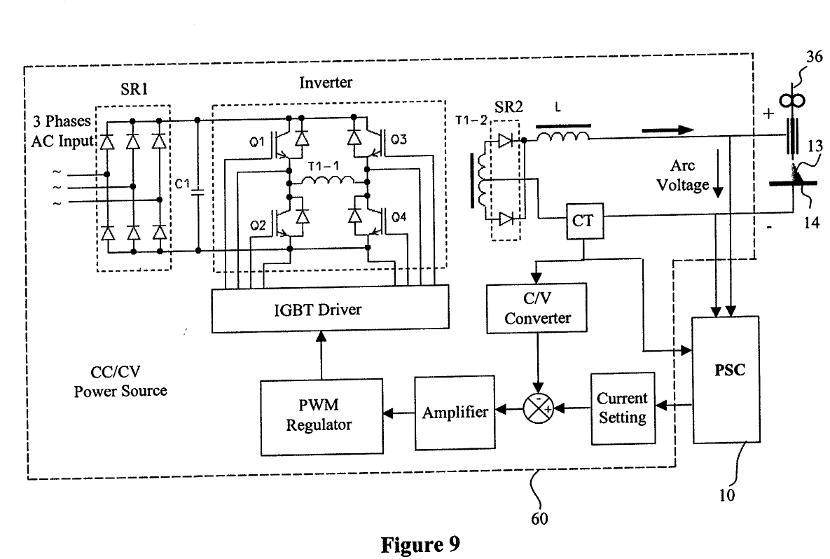

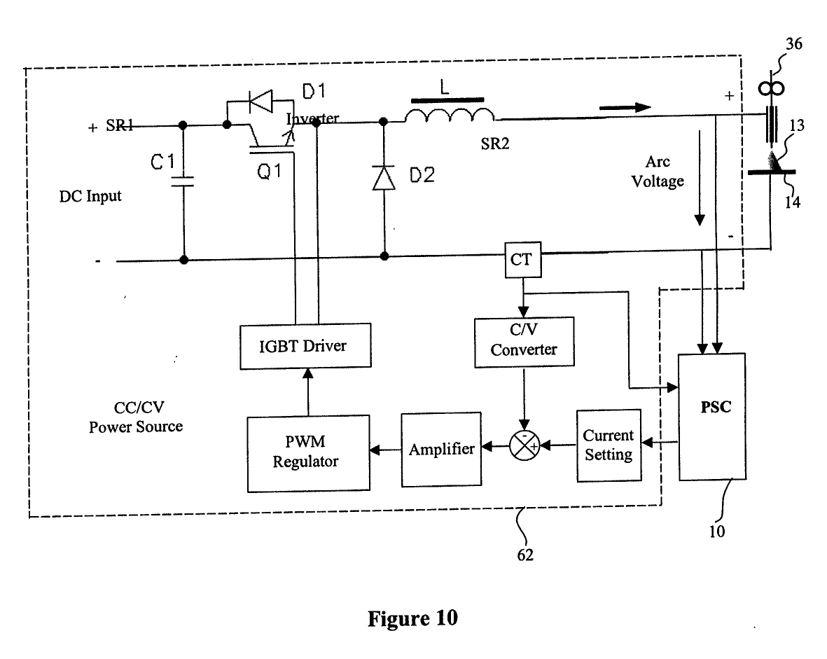

The CC power source should have a fast response dynamic characteristic so that it produces a high rate of change of current with time (dl/dt) at time t₁ when the tip of the electrode wire 36 touches the workpiece 14, see FIG. 7(b). For this reason, a fast response power supply is preferable, and the power supply 16 may be a commercial CC power supply such as that shown in FIGS. 9 and 10. FIG. 9 shows a typical inverter power supply, and the FIG. 10 shows a typical chopper-based power supply. Both power supplies are termed switch power supplies. The applied current during arc welding is controlled by turning off or on the solid-state switches (Q1, Q2, Q3 and Q4 in FIG. 9 or Q1 in FIG. 10) and by varying the ratios of the on- and off times. The repetition rate during switch closure should exceed 20 KHz since this produces a fast response to the signal from controller 10 and provides rapid control of the arc. Current feedback makes the volt-amp characteristic constant current in nature.

Referring again to FIG. 6, the current transformer 40 and the current/voltage converter circuit [M2] in the current detector 30 convert the arc current to a voltage signal. The amplifier A5 located in current detector 30 is used as a comparator. A fixed reference voltage Vₗ is applied to the (−) input of amplifier A5 and the time-varying voltage signal U_{M2} that is proportional to the arc current Iₒ is applied to the (+) input of amplifier A5. The output voltage U8 produced by amplifier A5 is exactly synchronized with the start of the arc initiation period, see FIG. 7(c). When voltage U8 is zero (the low level), the output of the timer unit 26 is “0” (the low level). The timer unit 26 is then triggered by voltage U8 at time t₁. After the period of time Tₛ (between t₁ and t₂ in FIG. 7(d)), the output of the arc starting timer unit 26 changes to “1” (the high level), see FIG. 7(d). The analog switch S in CC-CV switch 18 is controlled by the output voltage U3 of the arc starting timer unit 26. When the output voltage U3=“0” (the low level) the analog switch S in the CC-CV switch unit 18 is ON, see FIG. 7(d). This makes voltage U_{C1}=U9. Amplifier A1 in switch unit 18 is a voltage follower with an output voltage U4=U_{C1} ((+) input on amplifier A1). During the period Tₛ voltage U4=U9, see FIG. 7(e). Consequently, the (+) input of amplifier A2 in amplifier unit 22 is equal to the (−) input of amplifier A2. As result, the output voltage U5=0, see FIG. 7(f) and the output voltage U6 of amplifier A3 in unit 42 equals U1, see FIG. 7(g). Consequently, the voltage feedback function does not operate during the arc starting period Tₛ (from t₁ to t₂) when S is in the ON position and the output of power source 16 has a constant current characteristic.

M1 is an arc voltage sampler in the voltage detector unit 20. The output of voltage sampler M1 is proportional to the arc voltage Uₒ and U_{M1}=αU₀, where α is the rate of voltage stepdown in sampler M1. Capacitor C2 and resistor R2 act as a low pass filter, amplifier A4 is a voltage follower with its output voltage U9=αUₒ. The output (U3) of the arc starting timer unit 26 changes to “1” (the high level) at time t₂ and the analog switch S in the CC-CV switch unit 18 is turned off by the timer unit 26. S is now OFF, see FIG. 7(d). Although switch S is turned off at time t₂, the voltage U_{C1} on capacitor C1 in switch unit 18 cannot change immediately, so voltage U5 is still zero at time t₂. After time t₂, capacitor C1 is slowly charged or discharged by the normal arc voltage setting unit 28 via the resistor R1, and voltage U_{C1} will gradually change to voltage U2. This result is soft-switching from the CC to the CV mode of operation. Soft-switching is completed at time t₃ when voltage U4=U_{C1}=U2, see FIG. 7(e).

The soft-switch is designed to produce smooth switching from the CC to the CV mode of operation. After time t₃, the output voltage U5 of amplifier A2 is proportional to the difference between voltages U9 and U4. Voltage U5=K₂ (U9-U2), where K₂ is the voltage gain in amplifier A2, see FIG. 7(f). The output voltage U5 of amplifier A2 in unit 22 including the arc voltage feedback signal U9 is added to the (−) input of amplifier A3 in unit 42. The output voltage U6 of amplifier A3 in unit 42 is equal to K₃ (U1-K₂(U9-U2)), where K₃ is the voltage gain in amplifier A3, see FIG. 7(g). Therefore, arc voltage closed feedback initiates and the volt-amp characteristic of the CC power source 16 is switched to the constant voltage (CV) mode of operation, which is typically employed during Gas-Metal Arc welding.

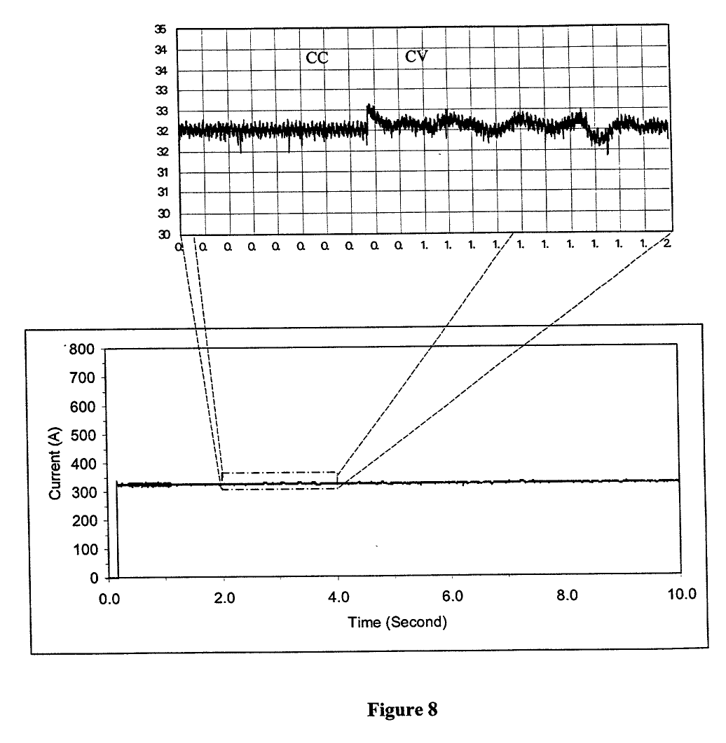

FIG. 8 shows the actual current and voltage waveforms produced when using the power source-conditioning unit 10 that is shown schematically in FIG. 6. Those skilled in the art will understand that the power source-conditioning unit 10 in FIG. 5 and shown schematically in FIG. 6, can be built into an inverter-based arc welding power source or any other kind of power source, which has a fast response dynamic characteristic. Also it can be made as a separate control unit to modify a conventional power source. Power supply 16 (in FIGS. 5 and 6) is a fast response power supply that can be made based on an inverter or a chopper construction shown in FIGS. 9 and 10. For example, power supply 60 in FIG. 9 is a typical inverter power supply; power supply 62 in FIG. 10 is a typical chopper power supply.

Closed-loop current feedback in power supplies 60 and 62 allows the power supplies to operate in CC mode. The CC power supply units 60 and 62 in FIGS. 9 and 10 respectively can be changed to a CV power supply when a closed-loop voltage feedback is applied via the power source conditioning unit 10 in FIGS. 9 and 10. The PSC unit is attached outside of the original closed-loop current feedback. FIGS. 9 and 10 also illustrate how a commercial CC/CV power supply operates, namely, the power supply's volt-amp characteristic will depend on the outer feedback loop when the power supply has two or more loops for feedback control. For system stability and reliability the inner-loop is a current-loop and the outer-loop is the voltage-loop in the many commercial CC/CV power supplies. The volt-amp characteristic of a commercial CC/CV power supply can be switched off-line between CC and CV by selecting the type of feedback desired. However, the volt-amp characteristic of the power supplies 60 and 62 in FIGS. 9 and 10 respectively can be dynamically switched on-line between CC and CV by using the PSC unit 10 in FIGS. 9 and 10 shown in the schematic diagram of FIG. 6.

In the above discussion it is assumed that stable operation of the Gas-Metal Arc welding process involves the spray mode of metal transfer. However, it will be understood that in some welding applications, e.g., positional welding, the desired metal transfer mode involves short-circuiting metal transfer. With this in mind, the inventors contemplate that current modification during the arc start period so that the welding conditions are similar to those required during short-circuit metal transfer may also minimize the start time and arc instability.

The dynamically on-line switchable power supply disclosed herein may be integrated with a microprocessor. For example, the functions of the arc starting current setting unit 24, arc starting time setting unit 26 and voltage setting unit 28 may be incorporated into a microprocessor which may have preprogrammed schedules or to permit operator intervention during the process. This also allows ease of monitoring the various outputs of these units in real time and permanent data records may be kept of each welding operation for quality control purposes and the like. Other features of the device may also be integrated with microprocessors for purposes of automation or producing robotic welding systems.

The present invention provides a new method of Gas-Metal Arc welding comprising using an initial constant current output of a power supply to initiate the plasma arc after which the output of the power supply is dynamically switched on-line to a constant voltage output. In addition, a new power supply controller has been disclosed which when retrofitted with various types of conventional power supplies provides for dynamic on-line switching between constant current and constant voltage modes. This invention also provides a new type of power supply produced by integrating the power supply controller 10 with a power supply to provide a dynamically switchable power supply between the two modes of constant current and constant voltage. Those skilled in the art will appreciate that this new type of power supply may be used for many applications other than Gas-Metal Arc welding and so the power supply disclosed herein is in no way limited to any one particular application.

Other examples of how arc initiation may be substantially improved in accordance with the present invention include superimposition of a higher average arc current value during the arc start period when using a CV, CV or CC/CV power supply, augmentation of the arc current during arc start period when using a CV power supply, and modification of the electrode composition in a way that increases the conductivity of the arc during the arc start period.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

Therefore what is claimed is:

1. A method of Gas-Metal Arc welding, comprising:
initiating a plasma arc between an electrode wire and a metallic workpiece to be welded using a power supply having a preselected substantially constant current output during an arc initiation period of time and thereafter said power supply being dynamically switched on-line to provide a preselected substantially constant voltage output giving a stable arcing period during Gas-Metal Arc welding.

2. The method according to claim 1 wherein said power supply includes a power supply controller having adjustment means for selecting said arc initiation period of time.

3. The method according to claim 2 wherein said power supply controller includes adjustment means for selecting said constant current output of said power supply, and wherein said power supply controller includes adjustment means for selecting said constant voltage output of said power supply.

4. The method according to claim 3 wherein said power supply is an inverter-based power supply or a chopper-based power supply.

5. A power supply controller for retrofitting to a power supply for on-line dynamic switching of the power supply between a constant current mode and a constant voltage mode, comprising:
a current selection means connected to said power supply for selecting a value of the current at an output of said power supply in the constant current mode, switch means connected to said power supply for switching said power supply between said constant current mode and said constant voltage mode on-line, voltage selection means connected to said switch means for selecting a value of the voltage at said output in the constant voltage mode, time selection means connected to said switch means for selecting an amount of time a constant current or constant voltage is applied to said output.

6. The controller according to claim 5 wherein said output includes first and second output conductors, including a voltage detector connected to said switch means for detecting a voltage across said first and second output conductors, and a current detector connected to said time selection means for detecting a current flowing in one of the first and second output conductors.

7. The controller according to claim 5 wherein said power supply is an inverter-based power supply.

8. The controller according to claim 5 wherein said power supply is a chopper-based power supply.

9. The controller according to claim 5 including a microprocessor integrated with said current selection means, said time selection means and said voltage selection means.

10. A power supply system that can be dynamically switched on-line between a constant current mode and a constant voltage mode, comprising:
a power supply having an output for delivering a current or voltage signal;
a power supply controller connected to said power supply for controlling constant current mode and constant voltage mode characteristics of said power supply, said controller including current selection means connected to said power supply for selecting a value of the constant current at said output, switch means connected to said power supply for switching said power supply on-line between said constant current mode and said constant voltage mode, voltage selection means connected to said switch means for selecting a value of the constant voltage at said output, time selection means connected to said switch means for selecting an amount of time a constant current or constant voltage is applied to said output.

11. The power supply system according to claim 10 wherein said output includes first and second outputs, and wherein said controller includes a voltage detector connected to said switch means for detecting a voltage across said first and second outputs, and a current detector connected to said time selection means for detecting a current flowing in one of the first and second outputs.

12. The power supply system according to claim 11 including a microprocessor integrated with said current selection means, said time selection means and said voltage selection means.

13. The welding system according to claim 11 wherein said current detector means includes a current transformer connected to said output.

14. A welding system for Gas-Metal Arc welding, comprising:
a power supply having a first output connected to an electrode wire and a second output connected to a workpiece to be welded, said power supply being adapted to operate in a constant current mode during an arc initiation period and thereafter in a constant voltage mode;
a power supply controller connected to said power supply for controlling constant current mode and constant voltage mode characteristics of said power supply and on-line dynamically switching said power supply between said constant current mode and said constant voltage mode;
a wire feeder for feeding electrode wire to a workpiece at which welding is to occur; and
a gas supply for providing a shielding gas to a welding site at said workpiece.

15. The welding system according to claim 14 wherein said power supply controller includes current selection means connected to said power supply for selecting a value of the constant current at said output, switch means connected to said power supply for on-line switching said power supply between said constant current mode and said constant voltage mode, voltage selection means connected to said switch means for selecting a value of the constant voltage at said output, time selection means connected to said switch means for selecting an amount of time a constant current or constant voltage is applied to said output, a voltage detector for measuring a voltage across said first and second outputs of said power supply connected to said switch means, and a current detector connected to said timer for detecting a current in one of the outputs of said power supply.

16. The welding system according to claim 15 wherein said current detection means includes a current transformer connected to said output.

17. The welding system according to claim 15 including a microprocessor integrated with said current selection means, said time selection means and said voltage selection means.

18. The welding system according to claim 14 wherein said power supply is an inverter-based power supply.

19. The welding system according to claim 14 wherein said power supply is a chopper-based power supply.
